(19) United States
(12) Patent Application Publication
(10) Pub. No.: US 2013/0080199 A1
(43) Pub. Date: Mar. 28, 2013

(54) Project Planner

(71) Applicants: Stefan Wenzel, Heidelberg (DE); Arne Schmidthals, Nussloch (DE); Thorsten Liebermann, Bensheim (DE)

(72) Inventors: Stefan Wenzel, Heidelberg (DE); Arne Schmidthals, Nussloch (DE); Thorsten Liebermann, Bensheim (DE)

(21) Appl. No.: 13/247,946

(22) Filed: Sep. 28, 2011

(51) Int. Cl. G06Q 10/00

(52) U.S. Cl. 705/7.11

(57) ABSTRACT

A landscape directory of a software integration architecture can be queried to obtain a listing of software services available for inclusion in a configuration of the software integration architecture that is presented to a user via a user interface. A selection of a set of services to be included in the configuration is received. For each service in the set of services, at least one database can be accessed to obtain information about the configuration to be presented via the user interface. The information can include pricing and implementation scheduling. Upon receipt of a confirmation of a final set of services for the configuration, a project plan can be generated and promoted. Related methods, systems, and articles of manufacture are also described.

### TECHNICAL FIELD

The subject matter described herein relates to planning of implementation projects, for example for new or modified installations of software integration architectures.

### BACKGROUND

Various organizations make use of enterprise resource planning (ERP) software or other business software integration architectures to provide an integrated, computer-based system for management of internal and external resources, such as for example tangible assets, financial resources, materials, customer relationships, and human resources. In general, an ERP or other software integration architecture is designed to facilitate the flow of information between business functions inside the boundaries of the organization and to manage the connections to outside service providers, stakeholders, and the like. Such architectures often include one or more centralized databases accessible by a core software platform that consolidates business operations, including but not limited to those provided by third party vendors, into a uniform and organization-wide system environment. The core software platform can reside on a centralized server or alternatively be distributed across modular hardware and software units that provide “services” and communicate over local connections or over a network, such as for example the Internet, a wide area network, a local area network, or the like.

As part of the installation process of the core software platform on computing hardware owned or operated by the organization, one or more customized features, configurations, business processes, or the like may be added to the default, preprogrammed features such that the core software platform is configured for maximum compatibility with the organization's business processes, data, and the like. Customized features, which can also be referred to as “add-on” features, can include optional services of the core software platform as well as services provided by one or more external service providers.

The core software platform of an ERP software architecture can be provided as a standalone, customized software installation that runs on one or more processors that are under the control of the organization. This arrangement can be very effective for a large-scale organization that has very sophisticated in-house information technology (IT) staff and for whom a sizable capital investment in computing hardware and consulting services required to customize a commercially available ERP or other software integration solution to work with organization-specific business processes and functions is feasible.

Smaller organizations can also benefit from use of ERP or other software integration functionality. However, such an organization may lack the necessary hardware resources, IT support, and/or consulting budget necessary to make use of a standalone ERP or other software integration architecture product and can in some cases be more effectively served by a software as a service (SaaS) arrangement in which the ERP or other software integration architecture is hosted on computing hardware such as servers and data repositories that are maintained remotely from the organization's location and accessed by authorized users at the organization via a thin client, such as for example a web browser, over a network.

### SUMMARY

In one aspect, a computer-implemented method includes querying a landscape directory of a software integration architecture to obtain a listing of software services available for inclusion in a configuration of the software integration architecture that is presented to a user via a user interface. A selection of a set of services to be included in the configuration is received from the user interface. For each service in the set of services, at least one database to obtain information about the configuration to be presented via the user interface, is accessed. The information includes pricing and implementation scheduling. Upon receipt of a confirmation of a final set of services for the configuration, a project plan is generated and promoted.

In some variations one or more of the following can optionally be included. A default set of services can optionally be provided and modified by the selection of the set of services received from the user interface. The promoting can optionally include at least one of presenting the project plan via the user interface, storing the project plan, transmitting the project plan over a network, and transmitting a summary of the project plan over the network. The promoting can also or alternatively optionally include presenting, via the interface, a purchase price corresponding to the project plan. The information about the configuration can optionally further include at least one of a number of users at an organization that uses or plans to use the software integration architecture, a projected usage amount of the software integration architecture by the organization, and a definition of one or more business processes that are used by the organization. The listing of software services available for inclusion in the configuration of the software integration architecture can optionally include software services provided by at least one of a core software platform of the software integration architecture and an external software component whose functionality is integrated into the software integration architecture.

Systems and methods consistent with this approach are described as well as articles that comprise a tangibly embodied machine-readable medium operable to cause one or more machines (e.g., computers, etc.) to result in operations described herein. Similarly, computer systems are also described that may include a processor and a memory coupled to the processor. The memory may include one or more programs that cause the processor to perform one or more of the operations described herein.

Implementations of the current subject matter can provide one or more advantages. For example, a comprehensive price quotation, which can optionally include license fees, consulting service expenses, software add-ons, etc.; an implementation proposal; or the like can be rapidly and automatically generated for use by a sales representative selling an ERP or other software integration architecture and/or by a prospective purchaser (e.g. a purchasing manager at a customer organization) who wishes to evaluate features, pricing, implementation timing, etc. for such an architecture.

The details of one or more variations of the subject matter described herein are set forth in the accompanying drawings and the description below. Other features and advantages of the subject matter described herein will be apparent from the description and drawings, and from the claims. It should be noted that, while descriptions of specific implementations of the current subject matter discuss delivery of enterprise resource planning software and in some examples delivery of enterprise resource planning software to multiple organizations via a multi-tenant system, the current subject matter is applicable to other types of software and data services access as well. The scope of the subject matter claimed below is therefore not limited except by the actual language of the claims.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a block diagram illustrating inputs to preparation of a project plan for a software integration architecture;

FIG. 2 is a process flow diagram illustrating aspects of a method having one or more features consistent with implementations of the current subject matter;

FIG. 3 is a diagram illustrating aspects of a system showing features consistent with implementations of the current subject matter; and

FIG. 4 is a diagram showing an example of a multi-tenant approach to providing customized software services to multiple organizations from a single architecture; and

FIG. 5 is a diagram showing storage of both core software package data objects and tenant-specific data objects for each of multiple tenants of a multi-tenant system.

When practical, similar reference numbers denote similar structures, features, or elements.

### DETAILED DESCRIPTION

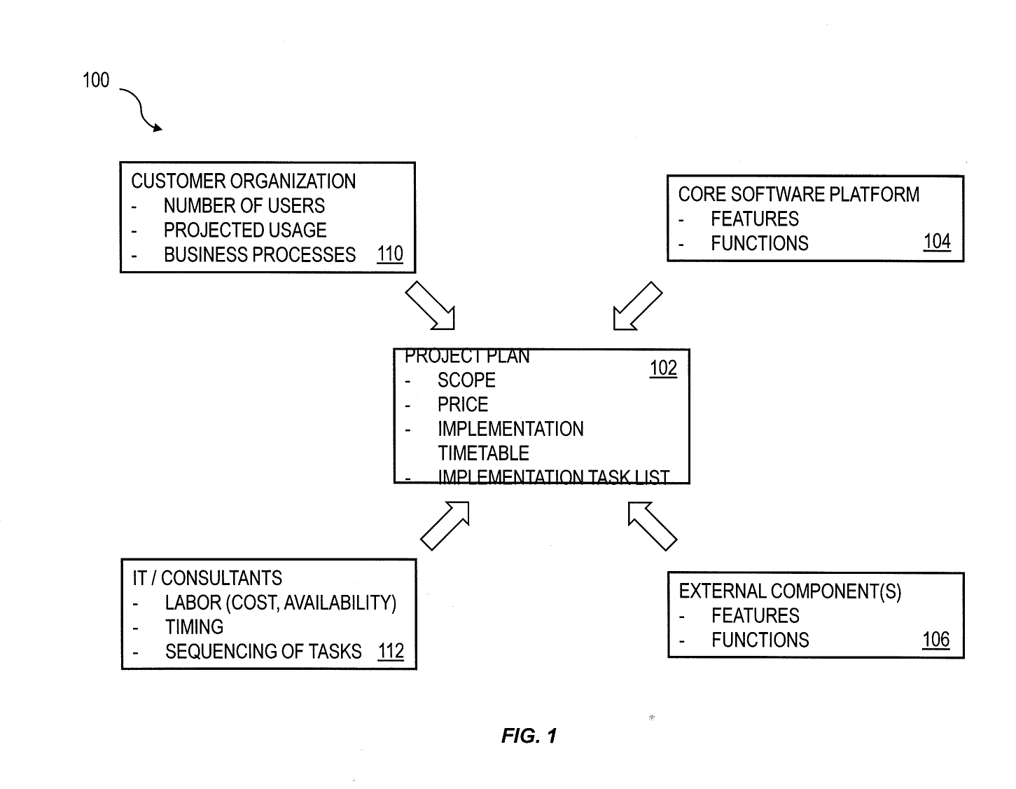

FIG. 1 shows a diagram illustrating data sources, services providers, and other aspects of a system architecture 100 that can serve as inputs to generation of a project plan 102. The project plan 102 can include one or more of a scope to be installed for a user organization (e.g. a company or corporation, division or department of a company or corporation, a non-profit organization, a government, etc.), pricing information, an implementation timetable and/or task list, and the like. A scope to be installed can include features, functions, and the like provided by a core software platform 104 of a software integration architecture or by one or more external components 106 that are accessible via and integrated by the core software platform 104. Information regarding the customer organization 110, such as for example business functions and processes of the customer organization 110, a number of users, projected usage of one or more available features by those users, etc., can be incorporated into the generated project plan 102. Also providing input can be one or more data sources relating to information technology and/or consultant services 112. Such data sources can include, but are not limited to, labor costs and availability, for example relating to timing of a project, and a preferred sequence with which implementation tasks are to be performed.

In a software delivery configuration in which services provided to each of multiple organizations are hosted on a dedicated system that is accessible only to that organization, the software installation at the dedicated system can be customized and configured in a manner similar to the above-described example of a standalone, customized software installation running locally on the organization's hardware. However, to make more efficient use of computing resources of the SaaS provider and to provide important performance redundancies and better reliability, it can be advantageous to host multiple tenants on a single system that includes multiple servers and that maintains data for all of the multiple tenants in a secure manner while also providing customized solutions that are tailored to each tenant's business processes.

Design and provisioning of an installation of an ERP or other integration architecture in a standalone, locally hosted environment is typically performed on a sufficiently large scale to justify the expense of consultants or in-house information technology labor to plan and implement a customized installation, for example by determining scope, pricing, and a duration and list of tasks necessary for implementation of the customized installation. In contrast, when an ERP or other integration architecture is provided via a SaaS approach, particularly to a smaller organization, such customization expenses can dramatically and undesirably alter the value proposition.

To address these and potentially other issues with currently available solutions, systems, methods, or articles of manufacture consistent with implementations of the current subject matter can, among other possible advantages, provide a project planning tool that allows a user to configure a software integration architecture (for example an ERP architecture) based on a guided procedure. Such a project planning tool can allow a user or a prospective user of a software integration architecture to explore the functions and features of a cores software platform of such an architecture and also to view, change, add, etc. available add-ons functions and additional services to a configuration or the architecture. A project planning tool can optionally provide a user with a proposed project timeline, a price estimation, and the like to aid a customer's buying decision making process. One or more algorithms can feed the project planner results to capture aspects relevant to a buying decision, for example including providing a quotation including solution scope, implementation project scope, and organizational information integrated into a single project planning tool. Such a project planning tool can also optionally include data regarding experiences from previous customers regarding business results according to choice of configuration variables.

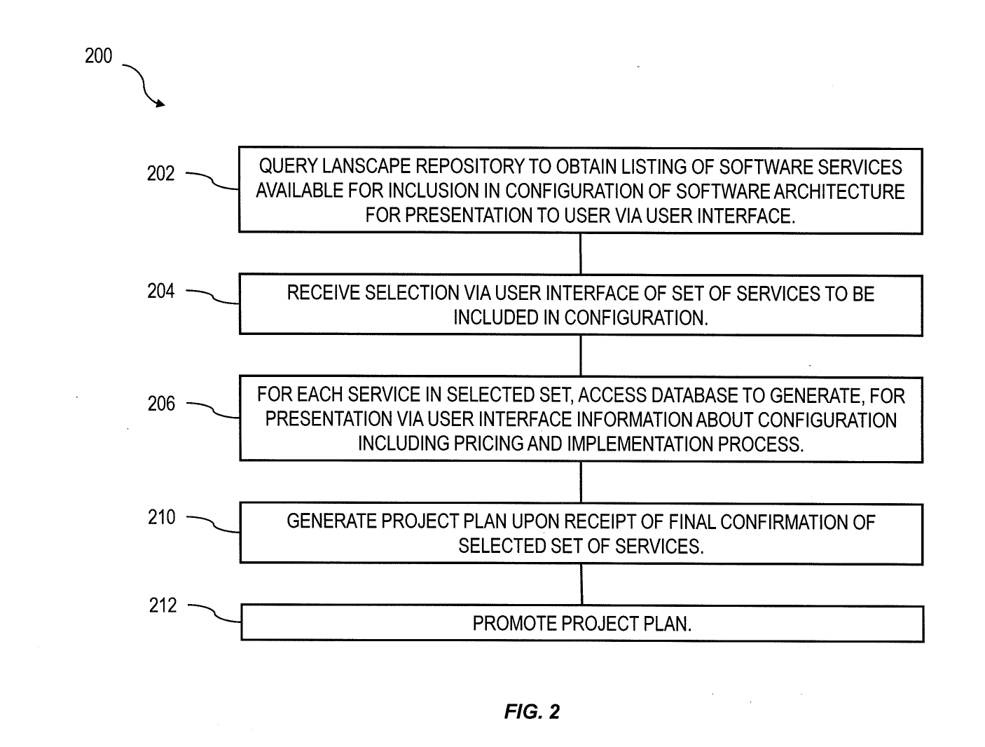

FIG. 2 shows a process flow chart 200 illustrating a method having features consistent with one or more implementations of the current subject matter. At 202, a landscape repository can be queried to obtain a listing of a plurality of software services available for inclusion in a configuration of a software integration architecture to be presented to a user. At 204, a selection of a set of services to be included in the configuration is received via a user interface in which the listing is presented. The set of services is selected from the plurality of services. At 206, at least one database is accessed to generate, for presentation at the user interface, information relating to the configuration. The information relating to the configuration can include, but is not limited to, a price and an implementation duration. At 210, upon receipt of a final confirmation of the configuration via the user interface, a project plan is generated. The project plan is promoted at 212, which can include one or more of presenting the generated project plan via the user interface, storing the project plan, transmitting the project plan or a summary thereof over a network, and the like.

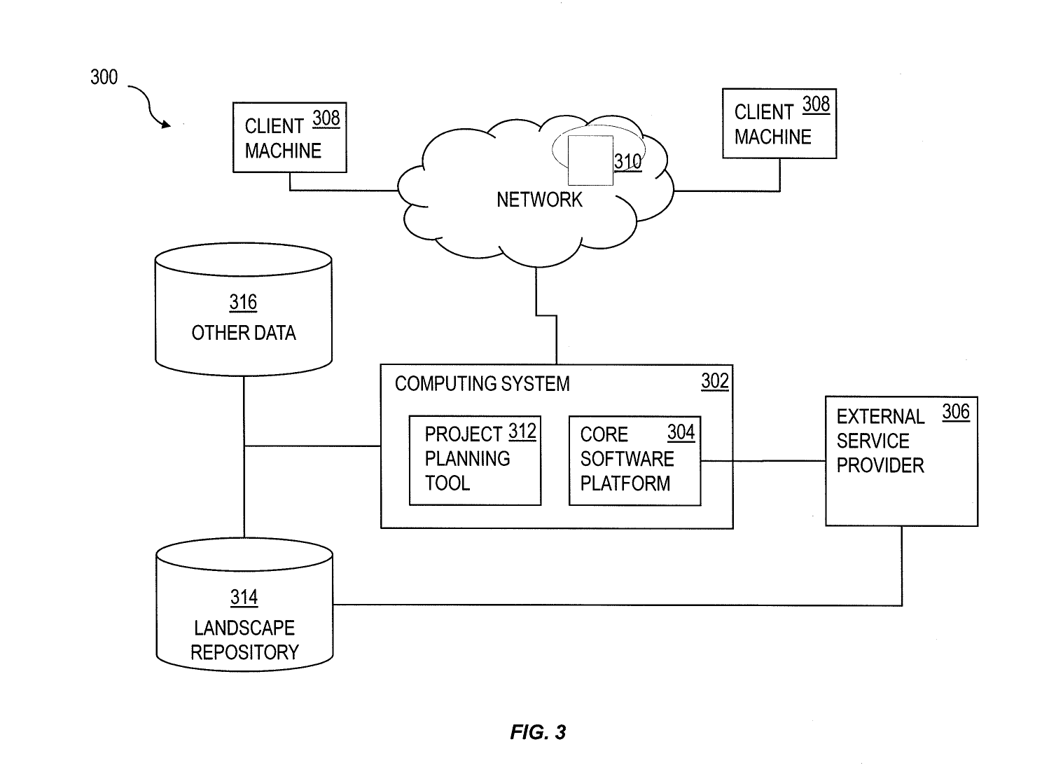

FIG. 3 shows an example of a system 300 consistent with the current subject matter. A computing system 302 that can include one or more programmable processors, which can be collocated, linked over one or more networks, etc., can execute one or more core software platform modules 304 that provide one or more ERP or other software application functions of the core software platform module(s) 304 and optionally of one or more external service provider software modules 306 such that the software application functions are accessible to local users as well as remote users accessing the computing system 302 from one or more client machines 308 via a network 310. One or more user interface screens produced by the one or more core software platform modules 304 can be displayed to a user, either via a local display or via a display associated with one of the client machines 308. A project planning tool module 312 can be implemented either on the computing system 302 as shown in FIG. 3 or on another machine or machines accessible to the computing system 302, for example over a networked connection. The project planning tool module 312 can provide one or more of the features and functions discussed above in regards to FIG. 2. The project planning tool module 312 can access a landscape repository 314 that can store information relating to services available for incorporation into a customized configuration of the software integration architecture. Services whose information is stored within the landscape repository 314 can include mandatory and optional feature, functions, etc. of the core software platform module(s) 304 as well as additional, “add-on” features provided by the one or more external service provider software modules 306 that can also be integrated into the configuration. One or more other data sources 316 can be accessible to the project planner, and can include information technology services data, user feedback for installed configurations sortable by selected configuration variables, and the like.

One or more core software platform modules 304 of an ERP or other software integration architecture can be provided as part of a standalone, customized software installation that runs on one or more processors that are under the control of an organization. This arrangement can be very effective for a large-scale organization that has very sophisticated in-house information technology (IT) staff and for whom a sizable capital investment in computing hardware and consulting services required to customize a commercially available ERP solution to work with organization-specific business processes and functions is feasible. Smaller organizations can also benefit from use of ERP functionality. However, such an organization may lack the necessary hardware resources, IT support, and/or consulting budget necessary to make use of a standalone ERP software architecture product and can in some cases be more effectively served by a software as a service (SaaS) arrangement. In a SaaS arrangement, the ERP system architecture (e.g. the core software platform) can be hosted on computing hardware such as servers and data repositories that are maintained remotely from the organization's location and accessed by authorized users at the organization via a thin client, such as for example a web browser, over a network.

In a software delivery configuration in which services provided to each of multiple organizations are hosted on a dedicated system that is accessible only to that organization, the software installation at the dedicated system can be customized and configured in a manner similar to the above-described example of a standalone, customized software installation running locally on the organization's hardware. However, to make more efficient use of computing resources of the SaaS provider and to provide important performance redundancies and better reliability, it can be advantageous to host multiple tenants on a single system that includes multiple servers and that maintains data for all of the multiple tenants in a secure manner while also providing customized solutions that are tailored to each tenant's business processes.

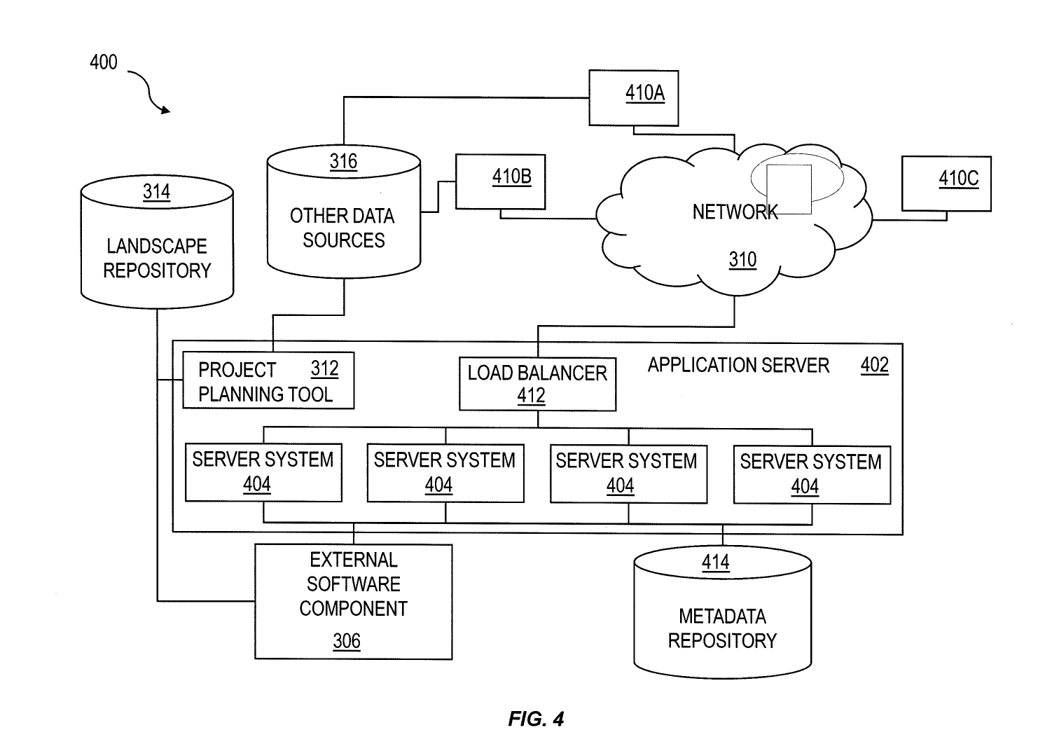

FIG. 4 shows a block diagram of a multi-tenant implementation of a software delivery architecture 400 that includes an application server 402, which can in some implementations include multiple server systems 404 that are accessible over a network 310 from client machines operated by users at each of multiple organizations 410A-410C (referred to herein as “tenants” of a multi-tenant system) supported by a single software delivery architecture 400. For a system in which the application server 402 includes multiple server systems 404, the application server can include a load balancer 412 to distribute requests and actions from users at the one or more organizations 410A-410C to the one or more server systems 404. A user can access the software delivery architecture across the network using a thin client, such as for example a web browser or the like, or other portal software running on a client machine. The application server 402 can access data and data objects stored in one or more data repositories 414. The application server 402 can also serve as a middleware component via which access is provided to one or more external software components 306 that can be provided by third party developers.

Similar to the system architecture illustrated in FIG. 3, a landscape directory 314 can receive information, for example by periodic querying or by being preprogrammed at regular or irregular intervals, pertaining to the services that can be included in a configuration of the landscape. One or more other data sources 316 can also be included to provide input to the project planning tool module 312, which can be implemented on the application server 402, or alternatively on an external machine having one or more separate processors. The one or more other data sources can include various information that can be obtained from the organizations 410A-410C (e.g. user counts, usage data, etc. as well as user feedback data and the like).

An additional possible application of a tool or software module, application, etc., implementing one or more features of the current subject matter can be to enable a vendor, sales agent, etc. of an ERP software suite or other business software architecture; a vendor, sales agent, etc. of a partner application that can be integrated within a business software architecture; or other software sales channel for an integrated software platform to offer a self-service scoping tool via which prospective customers can explore system capabilities, costs, hardware requirements, etc. prior to making a purchase decision. Based on one or more user selections of desired features, capabilities, etc. of the integrated software platform, the tool can generate one or more of a price, a project plan, or the like. Predictive calculations can be made based on information about typical customer efforts, consulting, costs, etc. then dynamically adjusted based on changed user selections. The tool can then allow the initiation of follow-on actions (e.g. request a quote, talk to a representative), and can progress to a “Buy Now” or similar feature to support a real-time purchase decision based on the scoping capabilities of the tool.

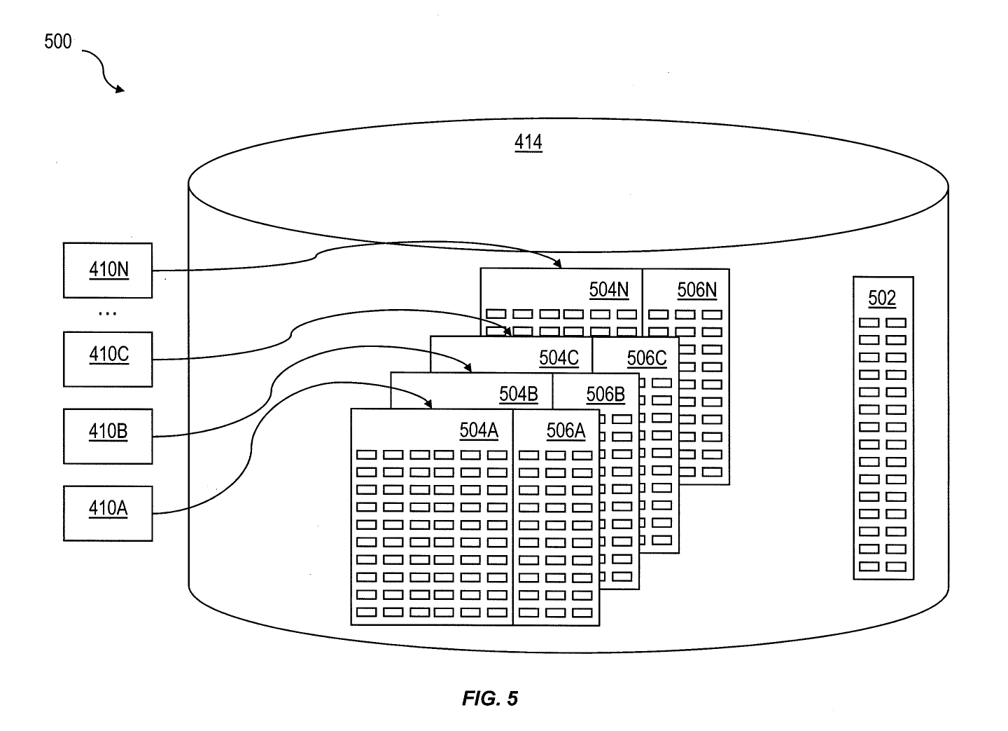

To provide for customization of the core software platform for each of multiple organizations supported by a single software delivery architecture 400, the data and data objects stored in the repository or repositories 414 that are accessed by the application server 402 can include three (or optionally more) types of content as shown in FIG. 5: core software platform content 502, system content 504, and tenant content 506. Core software platform content 502 includes content that represents core functionality and is not modifiable by a tenant. System content 504 can in some examples be created by the runtime of the core software platform and can include core data objects that are modifiable with data provided by each tenant. For example, if the core software platform is an ERP system that includes inventory tracking functionality, the system content 504A-504N can include data objects for labeling and quantifying inventory. The data retained in these data objects are tenant-specific: for example, each tenant 410A-410N stores information about its own inventory. Tenant content 506A-506N includes data objects or extensions to other data objects that are customized for one specific tenant 410A-410N to reflect business processes and data that are specific to that specific tenant and are accessible only to authorized users at the corresponding tenant. Such data objects can include a key field (for example “client” in the case of inventory tracking) as well as one or more of master data, business configuration information, transaction data or the like. For example, tenant content 506 can include condition records in generated condition tables, access sequences, price calculation results, or any other tenant-specific values. A combination of the software platform content 502 and system content 504 and tenant content 506 of a specific tenant are presented to users from that tenant such that each tenant is provided access to a customized solution whose data are available only to users from that tenant.

A multi-tenant system such as that described herein can include one or more of support for multiple versions of the core software and backwards compatibility with older versions, stateless operation in which no user data or business data are retained at the thin client, and no need for tenant configuration on the central system. As noted above, in some implementations, support for multiple tenants can be provided using an application server 402 that includes multiple server systems 404 that handle processing loads distributed by a load balancer 412. Potential benefits from such an arrangement can include, but are not limited to, high and reliably continuous application server availability and minimization of unplanned downtime, phased updating of the multiple server systems 404 to permit continuous availability (one server system 404 can be taken offline while the other systems continue to provide services via the load balancer 412), scalability via addition or removal of a server system 404 that is accessed via the load balancer 412, and de-coupled lifecycle processes (such as for example system maintenance, software upgrades, etc.) that enable updating of the core software independently of tenant-specific customizations implemented by individual tenants.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any faun, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer program product comprising a machine-readable medium storing instructions that, when executed by at least one programmable processor, cause the at least one programmable processor to perform operations comprising:
querying a landscape directory of a software integration architecture to obtain a listing of software services available for inclusion in a configuration of the software integration architecture that is presented to a user via a user interface;
receiving, from the user interface, a selection of a set of services to be included in the configuration;
accessing, for each service in the set of services, at least one database to obtain information about the configuration to be presented via the user interface, the information comprising pricing and implementation scheduling;
generating, upon receipt of a confirmation of a final set of services for the configuration, a project plan; and
promoting the project plan.

2. A computer program product as in claim 1, wherein the operations further comprise providing a default set of services that is modified by the selection of the set of services received from the user interface.

3. A computer program product as in claim 1, wherein the promoting comprises at least one of presenting the project plan via the user interface, storing the project plan, transmitting the project plan over a network, and transmitting a summary of the project plan over the network.

4. A computer program product as in claim 1, wherein the promoting comprises presenting, via the interface, a purchase price corresponding to the project plan.

5. A computer program product as in claim 1, wherein the information about the configuration further comprises at least one of a number of users at an organization that uses or plans to use the software integration architecture, a projected usage amount of the software integration architecture by the organization, and a definition of one or more business processes that are used by the organization.

6. A computer program product as in claim 1, wherein the listing of software services available for inclusion in the configuration of the software integration architecture comprises software services provided by at least one of a core software platform of the software integration architecture and an external software component whose functionality is integrated into the software integration architecture.

7. A system comprising:
at least one programmable processor; and
a machine-readable medium storing instructions that, when executed by the at least one processor, cause the at least one programmable processor to perform operations comprising:
querying a landscape directory of a software integration architecture to obtain a listing of software services available for inclusion in a configuration of the software integration architecture that is presented to a user via a user interface;
receiving, from the user interface, a selection of a set of services to be included in the configuration;
accessing, for each service in the set of services, at least one database to obtain information about the configuration to be presented via the user interface, the information comprising pricing and implementation scheduling;
generating, upon receipt of a confirmation of a final set of services for the configuration, a project plan; and
promoting the project plan.

8. A system as in claim 7, wherein the operations further comprise providing a default set of services that is modified by the selection of the set of services received from the user interface.

9. A system as in claim 7, wherein the promoting comprises at least one of presenting the project plan via the user interface, storing the project plan, transmitting the project plan over a network, and transmitting a summary of the project plan over the network.

10. A system as in claim 7, wherein the promoting comprises presenting, via the interface, a purchase price corresponding to the project plan.

11. A system as in claim 7, wherein the information about the configuration further comprises at least one of a number of users at an organization that uses or plans to use the software integration architecture, a projected usage amount of the software integration architecture by the organization, and a definition of one or more business processes that are used by the organization.

12. A system as in claim 7, wherein the listing of software services available for inclusion in the configuration of the software integration architecture comprises software services provided by at least one of a core software platform of the software integration architecture and an external software component whose functionality is integrated into the software integration architecture.

13. A computer-implemented method comprising:
querying a landscape directory of a software integration architecture to obtain a listing of software services available for inclusion in a configuration of the software integration architecture that is presented to a user via a user interface;
receiving, from the user interface, a selection of a set of services to be included in the configuration;
accessing, for each service in the set of services, at least one database to obtain information about the configuration to be presented via the user interface, the information comprising pricing and implementation scheduling;
generating, upon receipt of a confirmation of a final set of services for the configuration, a project plan; and
promoting the project plan.

14. A computer-implemented method as in claim 13, further comprising providing a default set of services that is modified by the selection of the set of services received from the user interface.

15. A computer-implemented method as in claim 13, wherein the promoting comprises at least one of presenting the project plan via the user interface, storing the project plan, transmitting the project plan over a network, and transmitting a summary of the project plan over the network.

16. A computer-implemented method as in claim 13, wherein the promoting comprises presenting, via the interface, a purchase price corresponding to the project plan.

17. A computer-implemented method as in claim 13, wherein the information about the configuration further comprises at least one of a number of users at an organization that uses or plans to use the software integration architecture, a projected usage amount of the software integration architecture by the organization, and a definition of one or more business processes that are used by the organization.

18. A computer-implemented method as in claim 13, wherein the listing of software services available for inclusion in the configuration of the software integration architecture comprises software services provided by at least one of a core software platform of the software integration architecture and an external software component whose functionality is integrated into the software integration architecture.

19. A computer-implemented method as in claim 13, wherein at least one of the querying, the receiving, the accessing, the generating, and the promoting are performed by at least one programmable processor.
